(19) United States
(12) Patent Application Publication
(10) Pub. No.: US 2002/0039497 A1
(43) Pub. Date: Apr. 4, 2002

(54) Contact type charger and electrophotographic printer using the contact type charger

(75) Inventors: Ryoichi Yasuda, Niigata (JP); Kazunori Shindo, Niigata (JP); Mabumi Kashihara, Niigata (JP)

Correspondence Address: OSTROLENK FABER GERB & SOFFEN, 1180 AVENUE OF THE AMERICAS, NEW YORK, NY, 100368403

(73) Assignee: NEC Corporation

(21) Appl. No.: 09/931,366

(22) Filed: Aug. 16, 2001

(30) Foreign Application Priority Data
Aug. 17, 2000 (JP) 247537/2000

(51) Int. Cl. G03G 15/02

(52) U.S. Cl. 399/89; 399/175; 399/176

(57) ABSTRACT

In a contact type charger including a charge roller which comes into contact with a photosensitive body and a power supply circuit which applies a direct-current fixed voltage to the charge roller, the power supply circuit further includes a resistor and applies the voltage to the charge roller through the resistor. Further, the power supply circuit includes a rectifying circuit and the resistor is disposed closer to the charge roller side than the rectifying circuit. Due to such a constitution, in response to an impedance between the photosensitive body and the charge roller, a current which flows into the charge roller is changed and an output voltage value is changed and hence, a fog on a background which is generated due to the change of the environment or change of the charge potential derived from the change of the film thickness of the photosensitive body can be prevented.

### BACKGROUND OF THE INVENTION

1. Field of the Invention

The present invention relates to a charger used for an electrophotographic printer, and more particularly to the constitution of a contact type charger.

2. Description of the Related Art

Recently, in the field of small-sized electrophotographic printers (hereinafter referred to as printers), a contact type charging method has been used in many cases. However, it has been known that, in this contact type charger, a resistance value of a conductive material of a charge roller and a discharge starting voltage in a gap between the charge roller and a photosensitive body are changed due to conditions of an environment where the printer is installed, particularly due to the humidity so that it is difficult to keep a surface potential of the photosensitive body constant.

On the other hand, a following electrophotographic printer is described in JP-A-6-11944. That is, as shown in FIG. 1, around a periphery of a photosensitive drum 51, a charger 52, an exposure device 53, a developing device 54, a transfer device 55, a cleaning part 56 and an electricity removal device 57 are arranged. The charger 52 is constituted of a charge roller 52a which is disposed so as to be in contact with the photosensitive drum 51 and a direct fixed current high voltage power supply 52b which supplies a voltage to the charge roller 52a. The charger 52 uniformly charges a surface of the photosensitive drum 51 at a given potential of negative polarity due to a discharge from the charge roller 52a generated by a voltage which is subjected to a fixed current control. The developing device 54 makes toners which are charged in positive polarity come into contact with the photosensitive drum 51 on which an electrostatic latent image is formed so as to visualize the electrostatic latent image. The transfer device 55 transfers the toners adhered to the photosensitive drum 51 onto a recording sheet with the use of a voltage of negative polarity.

On the other hand, JP-B2-2900510 discloses a method in which, during a rotation period in which a charge roller faces a non-image forming region surface of a drum, a direct-current fixed current control is performed, a direct voltage at this point of time is detected, and, based on this detected value, a drum surface is subjected to a charge processing in the direct-current fixed voltage control state during a period in which the drum surface faces an image forming region.

In these methods, since the direct-current fixed voltage control is performed during the formation of images, stains in a lateral stripe shape derived from pin holes on the above-mentioned photosensitive body are no more generated. Further, by keeping the current value at a fixed value, the change of a resistance value of the charge roller and the fluctuation of a charge potential of the photosensitive body due to the change of an environment including primarily the change of humidity can be suppressed.

However, in the case of JP-A-6-11944, there has been a drawback that when the fixed current control is performed, if a low resistance portion is present at a portion of the surface of the photosensitive body due to pin holes or the like formed in the photosensitive layer, the current concentrates on this portion and remarkably decreases the applied voltage value so that contamination in a lateral stripe shape appear on a printed image.

Further, in the method disclosed in JP-B2-2900510, as a high voltage power source, a detection circuit and a circuit for changing over a fixed current to a fixed voltage become necessary so that this makes the device large sized and complicated and pushes up the manufacturing cost.

Further, when the film thickness of the photosensitive body is changed due to manufacturing irregularities or wears thereof, the electrostatic capacity of the photosensitive body does not become the fixed value. In such a case, when the current value is made to take a fixed value, the surface potential of the photosensitive body is changed by an amount corresponding to the electrostatic capacity so that there has been a drawback that a fog on a background is generated or the density of the half tone dots becomes unstable.

### SUMMARY OF THE INVENTION

Accordingly, it is an object of the present invention to provide a contact type charger which can prevent a fog on a background which is generated due to the change of temperature and humidity and due to the change of a charge potential derived from the change of a film thickness of a photosensitive body.

According to the present invention, there is provided a contact type charger which includes a charge roller which comes into contact with a photosensitive body and a power supply circuit which applies a direct-current fixed voltage to the charge roller, wherein the improvement is characterized in that the power supply circuit includes a resistor and the power supply circuit applies the voltage to the charge roller through the resistor.

### BRIEF DESCRIPTION OF THE DRAWINGS

FIG. 1 is a schematic constitutional view of a charger in a conventional electrophotographic printer;

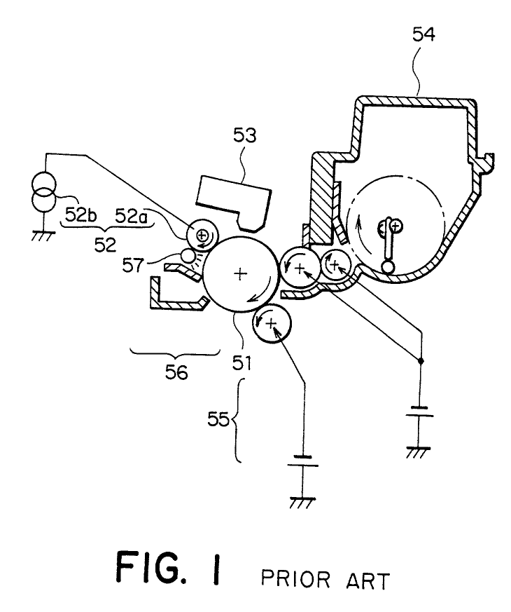

FIG. 2 is a schematic constitutional view showing an electrophotographic printer according to an embodiment of the present invention;

FIG. 3 is a schematic constitutional view of a charger in the electrophotographic printer according to the embodiment of the present invention;

FIG. 4 is a view showing ranges of conditions which do not generate a fog on background when the electrophotographic printer according to the embodiment of the present invention outputs images by changing an environment (temperature, humidity and a film thickness of photosensitive body); and

FIG. 5 is a view for explaining fog characteristics when the electrophotographic printer according to the embodiment of the present invention performs printing in respective environments.

### DESCRIPTION OF THE PREFERRED EMBODIMENTS

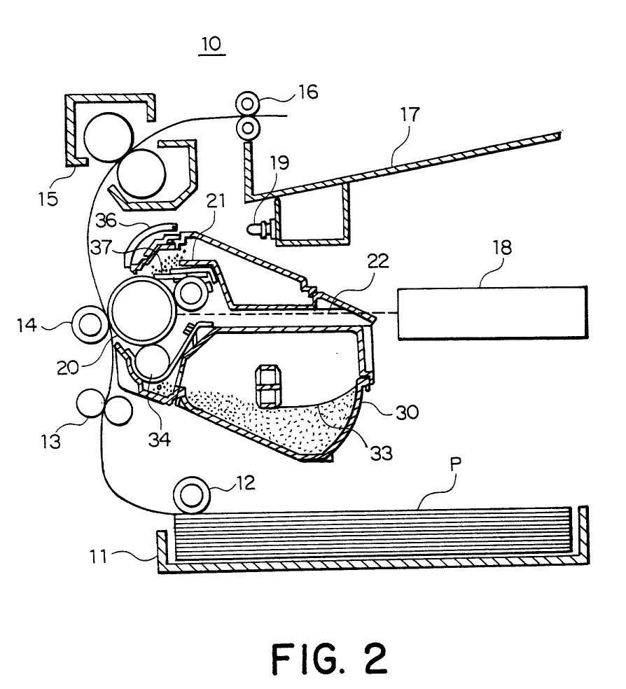

Subsequently, an embodiment of the present invention are explained in reference to attached drawings, wherein FIG. 2 is a schematic constitutional view showing the embodiment of the present invention.

Referring to FIG. 2, a printer 10 includes a sheet hopper 11 which stores recording sheets P which constitute recording mediums, a sheet feed roller 12 which takes out the recording sheet P from the sheet hopper 11 one by one, a guide roller 13 which guides the recording sheet P to be taken out onto a photosensitive body 20, a transfer roller 14 which is arranged to face the photosensitive body 20 in an opposed manner and transfers a toner image on the photosensitive body 20 to the recording sheet P, a fixing device 15 which fixes the transferred toner image onto the recording sheet P, a discharge roller 16 which discharges the recording sheet P to the outside of the device after fixing, and a sheet stacker 17 which stores the discharged recording sheets P.

Further, for the purpose of image formation, the printer includes exposure means 18 which exposes a charging surface of the charged photosensitive body 20 using a semi-conductor laser beam 22 so as to form an electrostatic latent image and an eraser 19 which irradiates an erasing light to make a potential on the photosensitive body after transferring uniform.

Here, numeral 30 in the drawing indicates an electrophotographic cartridge which is detachably mounted on the electrophotographic printer 10 and stores toners in the inside thereof. This electrophotographic cartridge 30 includes a charge roller 21 of a later-explained contact type charger (hereinafter referred to as charger) 2 for charging the photosensitive body 20, a developing roller 34 for applying the toners which are charged in polarity equal to that of the charge potential to the electrostatic latent image of the photosensitive body 20 to form a toner image, and a mixer 33 which conveys the toners stored in the inside of the electrophotographic cartridge 30 to a portion disposed in the vicinity of the developing roller 34.

Further, a shutter 36 has a function of an optical guide which leads the erasing light onto the surface of the photosensitive body 20 and is designed to be movable to a position which covers the photosensitive body 20 to protect the photosensitive body 20 when the cartridge is taken out to the outside of the device. Further, a cleaning blade 37 is provided for removing the residual toners after transferring the toner image from the sensitive body 20.

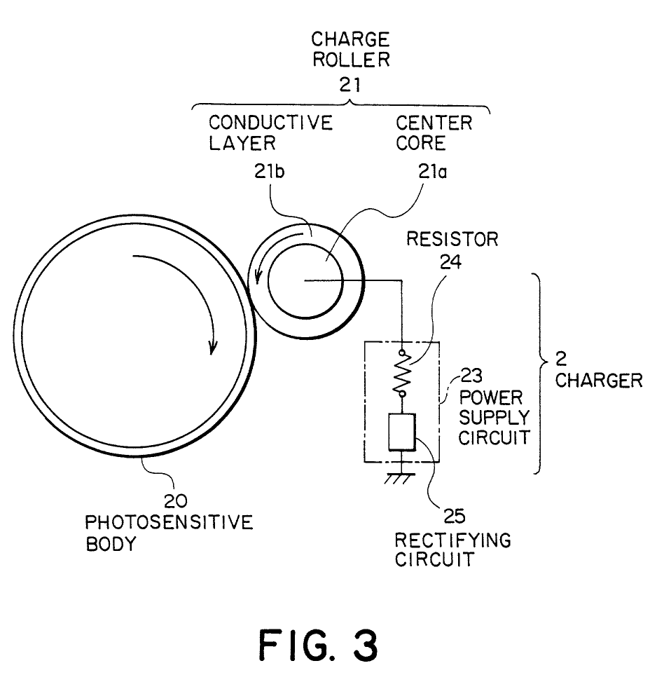

Then, FIG. 3 is an explanatory view for showing a schematic constitution of the charger 2. Referring to FIG. 3, the charger 2 includes a charge roller 21 constituting a charge member which comes into contact with the photosensitive body 20 and a power supply circuit 23 which applies a direct-current fixed voltage to the charge roller 21.

The charge roller 21 is constituted of a center core 21a and a conductive layer 21b which is formed on an outer periphery of the center core 21a. Both end portions of the center core 21a are rotatably supported by bearing means not showing in the drawing. The conductive layer 21b has a length of 317 mm to cover the length of an A3 sheet size. This charge roller 21 makes the conductive layer 21b thereof come into contact with the photosensitive body 20 and is rotated following the rotational drive (peripheral speed being 120 mm/sec) of the photosensitive body 20.

The center core 21a is connected to an output portion of the power supply circuit 23 for applying a voltage through a resistor 24 so that a given direct voltage is applied to the center core 21a. Material of the conductive layer 21b is epichlorohydrin rubber in which an ionic conductive material is mixed. The epichlorohydrin rubber having a resistance value of 180 kΩ, the hardness of 56 degree in JIS-A and the surface roughness in the rotation direction of Rmax 15 μm is used. Further, the press force of the charge roller 21 is set to 800 gf (7.84 N) as a total pressure.

The power supply circuit 23 is provided with a rectifying circuit 25 which includes a transformer and a bridge circuit. The power supply circuit 23 is also provided with the resistor 24 at a position closer to the charge roller 21 side than the rectifying circuit 25. Further, between the resistor 24 and the rectifying circuit 25 or at a location closer to the charge roller 21 than the resistor 24, other constitutions which are generally incorporated into the power supply circuit 23 (radiator and the like, for example) may be provided.

Subsequently, the manner of operation of the embodiment having such a constitution is explained.

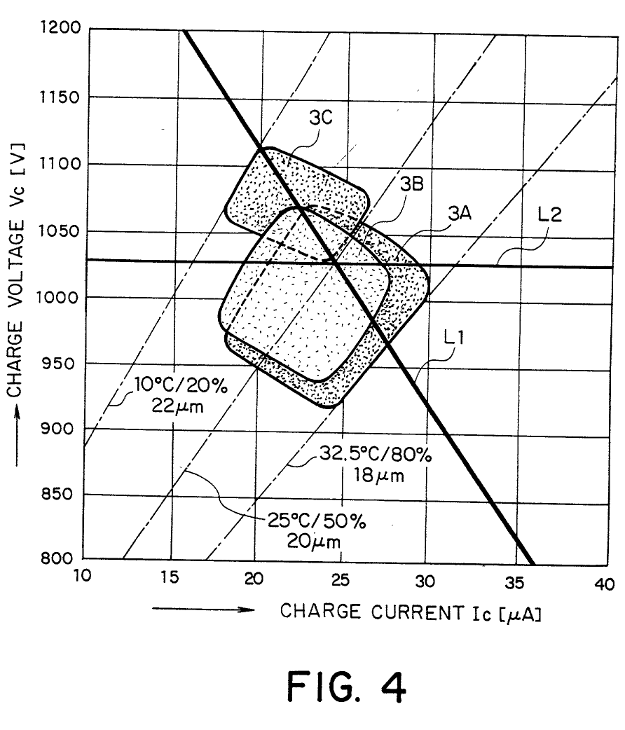

FIG. 4 is a view showing the drooping characteristics of the direct-current fixed voltage outputted from the power supply circuit 23 wherein the characteristic LI indicates the drooping characteristic of the power supply circuit 23 (this embodiment) and the characteristic L2 indicates the drooping characteristic of a conventional power supply circuit (comparison example) which is not provided with the resistor 24.

Referring to FIG. 4, in the case of the comparison example, although the voltage value exhibits the fixed value irrespective of the change of the current value. To the contrary, in this embodiment, when the impedance between the charge roller 21 and the photosensitive body 20 becomes small, the current flows into the charge roller 21 becomes large so that the output voltage value becomes low. Further, when the impedance is increased as an opposite case, the current which flows into the charge roller 21 becomes small so that the outputted voltage value becomes high. This is a characteristic which can be obtained by inserting the resistor 24 in series between an output portion transformer of the power supply circuit 23 and the center core 21a.

This drooping inclination is changed by changing the resistance value of the resistor 24. With respect to the constitution of this printer 10, it is desirable to set the resistance value within a range of approximately 1-80 MΩ. Here, the resistor 24 having the resistance value of 19.2 MΩ which is considered to be optimum is used. The optimum resistance value is determined based on the electrostatic capacity of the photosensitive body and the speed of printing process.

Here, assuming the electrostatic capacity of the photosensitive body as Cp F/m², the process speed as Vp m/sec, the width of the charge roller as L m, the charge surface potential as E₀, V, the charge current Ic A is expressed by a following equation.

Ic=Cp·L·Vp·E₀

On the other hand, assuming the inner resistance of the charge roller 21 as RrΩ and the discharge starting voltage as Eth V, the output voltage Ec V of the charger 2 can be expressed by a following equation.

Ec=E₀+Eth+Rr·Ic

Accordingly, the resistance value RcΩ of this charge process can be expressed by a following equation.

$$\begin{matrix}Rc = Ec / Ic = ( {E}_{0} + Eth ) / Ic + Rr \\ = ( {E}_{0} + Eth ) / ( Cp \cdot L \cdot Vp \cdot {E}_{0} ) + Rr\end{matrix}$$

Since the optimum resistance value RΩ of the resistor 24 of the present invention is proportional to the resistance value Rc of the photosensitive body having the standard film thickness (20 μm) when the charge process is performed under the normal temperature and normal humidity (usual temperature and humidity), a range 1-80 MΩ of the resistance value R can be expressed as follows using Rc.

0.022×Rc≦R≦1.766×Rc

Respective regions 3A, 3B, 3C in FIG. 4 indicate the condition ranges which do not generate the fog on the background at the time of outputting images by the printer when the mounting environment is respectively changed at 32.5°C./80% (temperature/relative humidity), 25°C./50% and 10°C./20%. Here, as the photosensitive body 20, the photosensitive bodies having a film thickness of 18 μm, 20 μm or 22 μm are used and the fog characteristic oranges when the film thickness is changed due to the irregularities in manufacturing and the wear caused by printing are investigated. Here, the electrostatic capacities of the photosensitive bodies are respectively set to 1.52×10⁻⁶, 1.37×10⁻⁶ and 1.25×10⁻⁶ F/m².

In the comparison example, as shown in the characteristic L2, even when the current value is changed due to the change of the environment, the output voltage value is fixed. Accordingly, even in the usual room temperature environment (25°C./50%), when the photosensitive body having a relatively thick film thickness (22 μm) is used, the fog is generated. Further, under the environment of 10°C./20%, the use of the photosensitive body of any film thickness generates the fog.

On the other hand, according to the embodiment of the present invention, although the embodiment indicates the same charge voltage as the comparison example under the condition of 25°C./50%, when the temperature and the humidity are changed, the current value is changed and hence, the output voltage is changed. In all range of film thickness of the photosensitive body and in all range of the temperature and the humidity, the charge voltage value always passes the inside of the regions 3A, 3B and 3C so that no fog is generated.

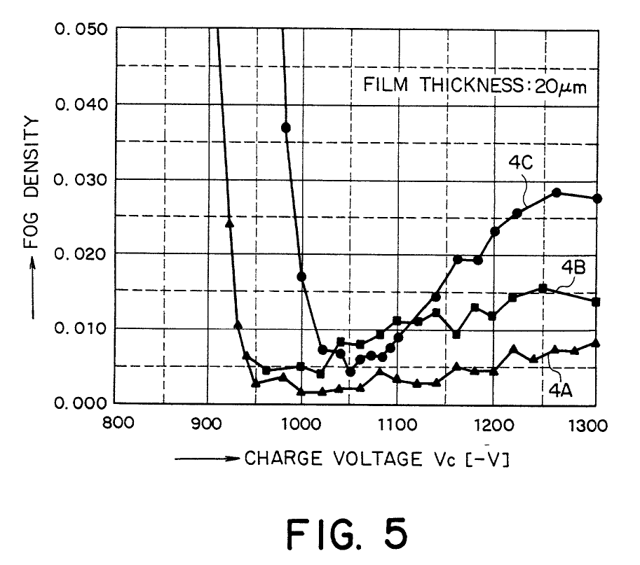

FIG. 5 shows the fog characteristics at the time of performing the printing in respective installation environments when the printer of the present invention is used.

Here, numerals 4A, 4B and 4C indicate the fog characteristics when the installation environment is respectively changed at 32.5°C./80% (temperature/relative humidity), 25°C./50% and 10°C./20%. Here, the film thickness of the photosensitive body is set to the standard thickness of 20 μm. A reflection density in a Macbeth densitometer is taken on the coordinate. In the observation with naked eyes, contamination on the background becomes apparent from around the density of 0.010 and reaches the so-called “noticeable level”

Although the charge roller is used in this embodiment, a charge brush which fixes bristles made of conductive rayon thereto can be used in place of the charge roller and the same advantageous effect can be obtained.

Then, Table 1 shows the charge voltages Vc at a lower limit and at an upper limit of a range in which the fog can be improved in observation with eyes which are obtained by performing the printing using the photosensitive bodies of three kinds of thickness in respective environments.

TABLE 1

| | film | output voltage of power supply Vc | | | | surface |
|---|---|---|---|---|---|---|
| environ- | thickness | lower | upper | | output | potential |
| ment | of photo- | limit | limit | | value | of photo- |
| con- | sensitive | value | value | margin | of em- | sensitive |
| dition | body | of fog | of fog | of fog | bodiment | body |
| 10° C./ | 22 μm | 1070 | 1120 | 50 | 1120 | 440 |
| 20% | 20 μm | 1050 | 1100 | 50 | 1070 | 410 |
| | 18 μm | 1040 | 1090 | 50 | 1040 | 390 |
| 20° C./ | 22 μm | 970 | 1060 | 90 | 1060 | 470 |
| 50% | 20 μm | 960 | 1050 | 90 | 1030 | 450 |
| | 18 μm | 930 | 1020 | 90 | 990 | 440 |
| 32.5° | 22 μm | 960 | 1070 | 110 | 1040 | 440 |
| C./ | 20 μm | 940 | 1050 | 110 | 1010 | 430 |
| 80% | 18 μm | 920 | 1030 | 110 | 980 | 420 |

Unit: V

As shown in Table 1, with respect to the fog characteristic at 10°C./20%, a range which has no problem extends from approximately 1050 V to 1100 V and this voltage width of 50 V is called “a margin of fog”. This margin of fog becomes narrowest when the environment condition is set to 10°C./20%, becomes 90 V when the environment condition is set to 25°C./50% and becomes equal to or more than 100 V when the environment condition is set to 32.5°C./80%.

This is because that the uniformity of the charge is changed mainly due to the humidity, wherein under the low-temperature and low-humidity environment in which the discharge starting voltage becomes high, the uniformity becomes the worst and hence, toners are adhered to non-charged regions when observed in a microscopic manner thus forming the fog.

Further, the output values of the embodiment shown in Table 1 indicate the charge potentials in the embodiment of the present invention in respective environment conditions and it is understood that the charge voltages fall between the upper limit and the lower limit of the fog.

As has been described heretofore, according to the present invention, it becomes possible to obtain the advantageous effect that the fog on the background which is generated due to the change of the installation environment or the change of the charge voltage derived from the change of the film thickness of the photosensitive body can be prevented with the use of simple constitution.

What is claimed is:

1. A contact type charger comprising a charge roller which comes into contact with a photosensitive body and a power supply circuit which applies a direct-current fixed voltage to the charge roller,
the improvement being characterized in that the power supply circuit includes a resistor and the power supply circuit applies the voltage to the charge roller through the resistor.

2. A contact type charger according to claim 1, wherein the charge roller is formed of a charge brush which fixes bristles made of conductive synthetic resin thereto.

3. A contact type charger according to claim 1, wherein the power supply circuit includes a rectifying circuit and the resistor is disposed closer to the charge roller than the rectifying circuit.

4. A contact type charger according to claim 1, wherein provided that the charge process is performed under a normal temperature and a normal humidity, a film thickness of the photosensitive body is of a standard thickness and a resistance value between the charge roller and the photosensitive body during a printing operation is set to RcΩ, the resistance value of the resistor is expressed as follows.
0.022×Rc≦R≦1.766×Rc

5. An electrophotographic printer being characterized by using the contact type charger according to claim 3.

6. An electrophotographic printer being characterized by using the contact type charger according to claim 4.
